(19) United States
(12) Patent Application Publication
(10) Pub. No.: US 2014/0196491 A1
(43) Pub. Date: Jul. 17, 2014

(54) Compact Computer Cooling Methods and Apparatus

(71) Applicants: Patrick Zuili, Boca Raton, FL (US); Todd Stabinski, Miami, FL (US); Daren Stabinski, Weston, FL (US); Joe Arnold, Oakland Park, FL (US)

(72) Inventors: Patrick Zuili, Boca Raton, FL (US); Todd Stabinski, Miami, FL (US); Daren Stabinski, Weston, FL (US); Joe Arnold, Oakland Park, FL (US)

(73) Assignee: POWERQUEST LLC, Miami, FL (US)

(21) Appl. No.: 14/239,726

(22) PCT Filed: Aug. 29, 2012
(86) PCT No.: PCT/US2012/052824

§ 371 Date: Feb. 19, 2014

Related U.S. Application Data
(60) Provisional application No. 61/528,726, filed on Aug. 29, 2011.

(51) Int. Cl. G06F 1/20; F25B 49/02

(52) U.S. Cl. CPC G06F 1/206; F25B 49/022
USPC 62/115; 361/679.53; 361/679.48; 62/228.1

(57) ABSTRACT

Systems and methods are provided for controlling the temperature of an electronic component of a computer. In one embodiment, a system includes a compressor, a compact cooling block, a condenser, and a controller. The compressor compresses or cools a refrigerant. The condenser receives the refrigerant and condenses the refrigerant. The compact cooling block is thermally coupled to an electronic component of a computer, receives the refrigerant from the condenser, transfers thermal energy from the electronic component to the refrigerant, and sends the refrigerant to back to the compressor. The controller is in electronic communication with the compressor and controls the compressor based on a pulse-width modulation (PWM) signal in order to maintain a temperature range for the electronic component. In another embodiment, a system is provided that controls the temperature of a circulating liquid that, in turn, cools an electronic component of a computer.

### CROSS-REFERENCE TO RELATED APPLICATION

This application claims the benefit of U.S. Provisional Patent Application No. 61/528,726 filed Aug. 29, 2011, which is incorporated by reference in its entirety.

### INTRODUCTION

Personal computers today mainly use fans that blow air from the outside environment into the computer case and past the electronic components, such as the central processing unit (CPU), graphics processing unit (GPU), Northbridge (NB), voltage regulator, hard drives, solid state drives, memory, networks cards, or any add-on cards and motherboards. Often the CPU and GPUs, networks cards, or any add-on cards are connected to heat sinks to absorb the heat from these components. However, air is still used to remove the heat from the heat sinks.

In the commercial arena, most small businesses do not use any specific means to cool down their server rooms. Instead they typically use their pre-existing air conditioning systems, which may provide a fixed (e.g., 68F) temperature for the room. No other methods are used to verify that this fixed temperature is constant. Often the same air conditioning system used for the server room is the exact same one used to cool down the offices nearby, because the cost to install a dedicated cooling system just for the servers in a small business is far too expensive to install and operate.

In larger businesses, companies spend a great deal of money on special infrastructure, such as large air conditioning units and architecture, and on energy costs, to properly cool their server computers, without solving problems encountered by existing technology as described below.

With existing technology, it is commonly known that cooling computers and servers is a difficult and inefficient task for multiple reasons. The first issue is that current technology uses air conditioning that cools the entire room in order to cool very small processors and electronic components within the computer, resulting in wasted energy. Existing technology also does not change the cooling capacity of the air conditioning based on the load of the computer, further wasting energy. Existing technology uses air to cool the electronic components, which is an inefficient method of heat transfer. Also, by blowing air through the computer, the electronic components are exposed to dust, moisture, and static, which are major causes of computer failure.

Water cooling is another existing technology that is used occasionally in higher end personal computers, and sometimes in commercial computers. In water cooling, water is piped into the computer through rigid or flexible tubing, and passed through solid metal cooling blocks attached to the hot electronic components. The water removes the heat from the blocks and is typically piped out of the computer into a radiator and fan apparatus, which removes the heat from the water, and the cycle is then repeated. While water cooling is more efficient than air cooling, it presents other problems. First, if the electronics are directly exposed to water, it will most likely cause short circuit and permanent damage. Second, water cannot be cooled to temperatures lower than the dew point, or else it will cause condensation on the cooling blocks and again expose the electronics to water and potential permanent damage.

Water and air cooling have additional limitations. The load of the processors that produce the heat is dynamic, while the amount of cooling provided by air and water cooling is generally constant. While there is a slight change in the rate of cooling based on the fan (air cooling)/pump (water cooling) speed when the temperature of the CPU/GPU increases or decreases, this change does not result in a significant increase in the amount of cooling provided. Moreover, the temperature of a processor increases or decreases very rapidly within a large range of temperatures. For example, the temperature of a CPU may increase from 30 C to 90 C in a matter of seconds when the load of the computer increases from 0% to 100%. Air and water cooling does not react as fast as a processor changes temperature. This delayed reaction becomes more exaggerated when using hotter or overclocked processors, even to the point that air and water cooling cannot cool the processor fast enough to prevent it from reaching critical temperature that require a shutdown of the computer or that may result in damage to the processor.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is an exploded view of a system for controlling the temperature of an electronic component of a computer, according to an embodiment of the present invention.

FIGS. 2A, 2B, and 2C show side, bottom, and top views, respectively, of the compact cooling block of FIG. 1, according to an embodiment of the present invention.

FIG. 3 is a flowchart showing a method for controlling the temperature of an electronic component of a computer, in accordance with various embodiments.

FIG. 4 is a schematic diagram of a system of distinct software modules that performs a method for controlling the temperature of an electronic component of a computer, in accordance with various embodiments.

FIG. 5 is a schematic diagram of a system for controlling the temperature of a circulating liquid used to control the temperature of an electronic component of a computer, in accordance with various embodiments.

FIG. 6 is a schematic diagram of a computer that contains a system for controlling the temperature of a circulating liquid used to control the temperature of an electronic component of the computer, in accordance with various embodiments.

Before one or more embodiments of the invention are described in detail, one skilled in the art will appreciate that the invention is not limited in its application to the details of construction, the arrangements of components, and the arrangement of steps set forth in the following detailed description. The invention is capable of other embodiments and of being practiced or being carried out in various ways. Also, it is to be understood that the phraseology and terminology used herein is for the purpose of description and should not be regarded as limiting.

### DETAILED DESCRIPTION

The detailed description of the present invention is presented largely in terms of procedures, steps, logic blocks, processing, or other symbolic representations that directly or indirectly resemble the operations of devices or systems that produce coldness or cooling effect. These descriptions and representations are typically used by those skilled in the art to most effectively convey the substance of their work to others skilled in the art.

Reference herein to “one embodiment,” “various embodiments,” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

Further, the order of blocks in process flowcharts or diagrams or the use of sequence numbers representing one or more embodiments of the invention do not inherently indicate any particular order nor imply any limitations in the invention. Referring now to the drawings, in which like numerals refer to like parts throughout the several views.

### Electronic Component Cooling System

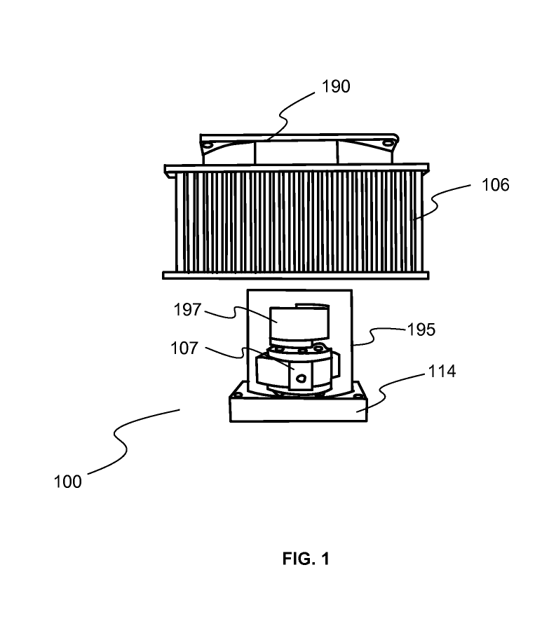

FIG. 1 is an exploded view of a system 100 for controlling the temperature of an electronic component (not shown) of a computer. System 100 includes a compact cooling block 114 for an electronic component (not shown). The electronic component can be, but is not limited to, a central processing unit (CPU) or graphics processing unit (GPU) of a computer. Compact cooling block 114 may be referred to as CPU cooling block or GPU cooling block, for example. Compact cooling block 114 is in direct physical and thermal contact with the electronic component.

In various embodiments, system 100 further includes a compressor 107, 197 and a condenser 106, such as a condenser coil. Condenser 106 is capable of condensing a refrigerant. Compressor 107, 197 can be a compressor that is used to compress the pressure of compressible fluids, such as a refrigerant gas whose density varies with pressure. Compressor 107, 197 can also be a pump that is used to increase the pressure of an incompressible fluid whose density is constant for a change in pressure.

In various embodiments, compressor 107, 197 includes two parts: direct current (DC) motor 197 and compression mechanical chamber 107. In one embodiment, a shaft (not shown) provides a link between DC motor 197 and compression mechanical chamber 107. By extending the shaft, DC motor 197 is located outside of compressor enclosure 195, allowing easy maintenance and retrofit of DC motor 197.

In various embodiments, compressor 107, 197 has an enclosure 195. Compressor 107, 197 and its enclosure 195 are surrounded by condenser 106. In various embodiments, condenser 106 takes various forms and designs, including but not limited to, circular, octagonal, and curved.

In various embodiments, system 100 further includes a back plate 190 affixed to enclosure 195. Back plate 190 is used to attach compact cooling block 114 to a motherboard's chassis, for example, so that compact cooling block 114 is in direct contact with the electronic component. In various embodiments, compact cooling block 114 is attached to the motherboard's chassis where the motherboard is screwed in place. This embodiment prevents the motherboard from bending or vibrating due to the weight of compact cooling block 114.

In various embodiments, compressor 107, 197 is mounted on compact cooling block 114 with a small angle of, for example, 3 degrees. The small angle prevents oil from migrating out of the compressor if the chassis of the computer is positioned either vertically or horizontally.

In various embodiments, the refrigerant is a refrigerant gas, such as chlorofluorocarbon or hydrofluorocarbon. The refrigerant gas is compressed by compressor 107, 197, and sent as a hot, high pressured gas to condenser 106. In various embodiments, condenser 106, which surrounds compressor 107, 197 and compact cooling block 114, includes a condenser fan (not shown). The condenser fan removes heat from the gas state of the refrigerant and thus condenses the hot, high pressured gas to a liquid state. In various embodiments, the high pressure cooled liquid refrigerant is then sent to compact cooling block 114. Compact cooling block 114 includes capillary tubing or a micro jet (not shown) to allow the liquid refrigerant to change phase into a cold gas ready to absorb the heat of the electronic component. In various embodiments, the refrigerant is then sent back to compressor 107, 197 to be to repeat the cycle.

In various embodiments, the entire system 100, which includes compact cooling block 114, compressor 107, 197 and its enclosure 195, condenser 106, and plate 190, is located inside a chassis (not shown) of a computer. Alternatively, system 100 is located outside of the chassis.

In various embodiments, compressor 107, 197 is connected to a compressor controller (not shown) and its power supply (not shown).

In various embodiments, compact cooling block 114 includes a sensor (not shown) that is used to measure the temperature of the attached electronic component and/or the temperature and humidity of the ambient air. In various embodiments, the sensor is connected to a controller or circuit board (not shown) that is controlled by a separate computer. The controller or circuit board monitors the temperature and/or load of the electronic component, and controls the speed of compressor 107, 197 via the compressor controller based on pre-defined values. Alternatively, the controller or circuit board turns compressor 107, 197 on or off via the compressor controller based on pre-defined values.

In various embodiments, the controller or circuit board is directly connected to the basic input/output system (BIOS) of the computer to control the cooling level by monitoring the load of the electronic components and increasing or decreasing the cooling capacity when needed. A computer normally uses its BIOS (smart fan) to monitor the (temperature and/or load) of the processor (or other electronic components) and delivers electricity to the computer fan in the form of pulse-width modulation (PWM) from 0-12 volts. Therefore, as the temperature and/or load increases, the fan speed increases in order to remove more heat. In various embodiments, compressor 107, 197 is controlled by a linear voltage from 0-5 volts. The controller or circuit board of system 100 converts the 0-12 volt PWM signal normally meant for the computer fan to a linear voltage in the range of 0-5 volt in the same proportion to allow the BIOS to control the speed of compressor 107, 197 in the same manner that it normally controls the computer fan based on the temperature and/or load of the processor. One skilled in the art will appreciate that the same design may be used to convert the PWM signal to any linear voltage (such as 0-12 volts or 0-24 volts) depending on the compressor controller used. A universal serial bus (USB) connection may be used to perform voltage adjustments through a device driver allowing local and/or remote operation and maintenance of the cooling circuit.

In various embodiments, when the temperature of the electronic component rises, the compressor controller senses that the temperature is higher than a pre-defined value preset by the BIOS of the computer and sends a signal to the controller or circuit board, which changes the 0-12 volt PWM signal to a 0-5 volt direct current (DC) signal. In various embodiments, the 0-5 volt DC signal is sent to the compressor controller. When the temperature of the electronic component is stabilized to the pre-defined value preset by the BIOS, the BIOS sends an appropriate voltage to lower the revolutions per minute (RPM) of compressor 107, 197.

The PWM signal may be configured by a user directly using the computer BIOS, software, or application programmable interface (API). For example, the user can input a temperature or range of temperatures for the electronic component.

In various embodiments, the temperature sensor located on compact cooling block 114 provides a redundant security check in case of heat approaching upper or lower limits and acts as a secondary controller, preventing condensation on compact cooling block 114 itself.

In various embodiments, system 100 can also control solenoid values to control the flow of refrigerant based on temperature and/or load. If two PWM to linear circuit boards are require to be connected in parallel (e.g., using a dual processor motherboard with a single compressor), then a diode is added to the 0-5V output in order to prevent current flow-back.

In various embodiments, system 100 provides a compact cooling block that is easy to retrofit. All of the components of compact cooling block 114, either with high or low pressures, are not accessible to computer end users. Tubing may be limited to the essential parts, such as tubing from compressor 107, 197 to condenser 106, tubing from condenser 106 to the compact cooling block 114, and back to compressor 107, 197 located in compact cooling block 114. The tubing may be included in enclosure 195 so that the tubing is inaccessible from outside.

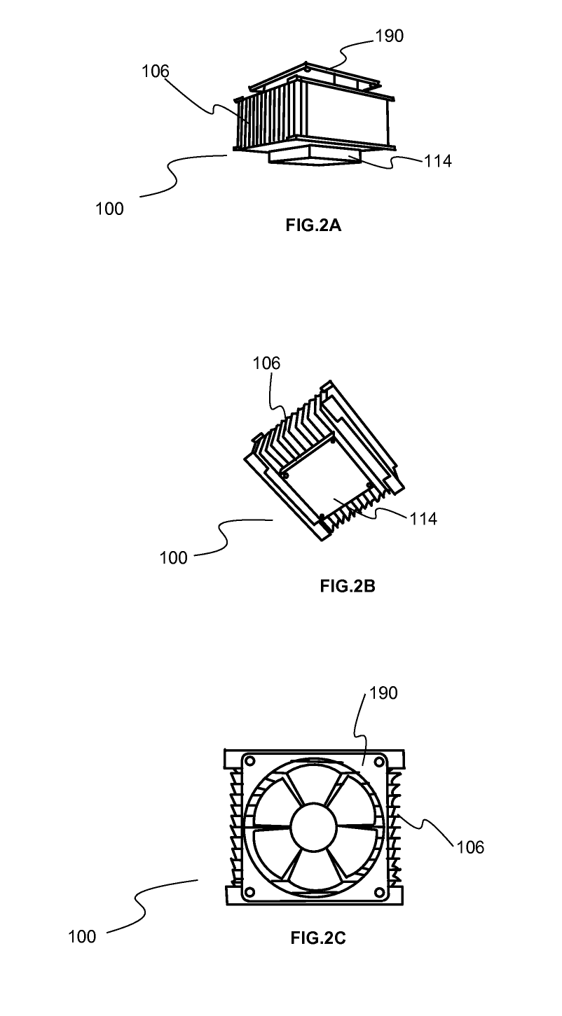

FIGS. 2A, 2B, and 2C show side, bottom, and top views, respectively, of the compact cooling block of FIG. 1, according to an embodiment of the present invention.

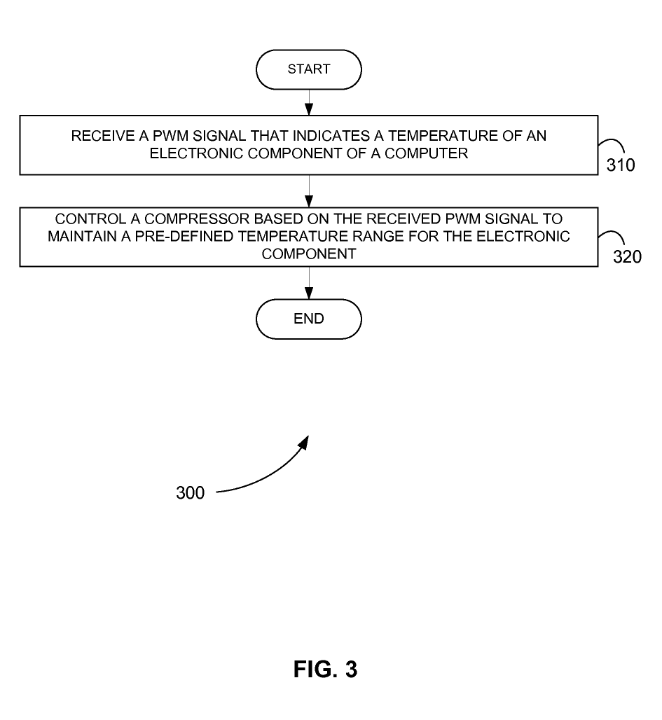

FIG. 3 is a flowchart showing a method 300 for controlling the temperature of an electronic component of a computer, in accordance with various embodiments.

In step 310 of method 300, a PWM signal is received that indicates a temperature of an electronic component of a computer.

In step 320, a compressor is controlled based on the received PWM signal to maintain a pre-defined temperature range for the electronic component. The compressor compresses a refrigerant. The refrigerant is sent to a condenser that condenses the refrigerant. The refrigerant is then sent to a compact cooling block that is thermally coupled to the electronic component and that transfers the thermal energy from the electronic component to the refrigerant. Finally, the refrigerant is sent back to the compressor. The compressor, the condenser, the compact cooling block, and the controller all fit within a chassis of the computer.

In various embodiments, a computer program product includes a tangible computer-readable storage medium whose contents include a program with instructions being executed on a processor so as to perform a method for controlling the temperature of an electronic component of a computer. This method is performed by a system of distinct software modules.

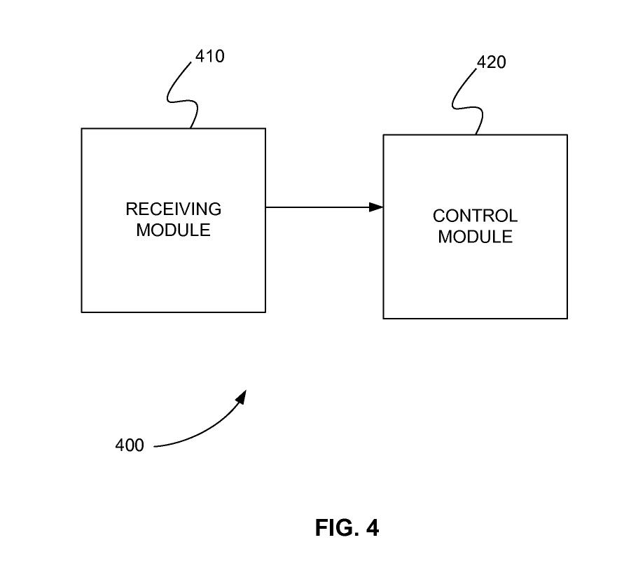

FIG. 4 is a schematic diagram of a system 400 of distinct software modules that performs a method for controlling the temperature of an electronic component of a computer, in accordance with various embodiments. System 400 includes a receiving module 410 and a control module 420.

Receiving module 410 receives a PWM signal that indicates a temperature of an electronic component of a computer.

Control module 420 controls a compressor based on the received PWM signal to maintain a pre-defined temperature range for the electronic component. The compressor compresses a refrigerant. The refrigerant is sent to a condenser that condenses the refrigerant. The refrigerant is then sent to a compact cooling block that is thermally coupled to the electronic component and that transfers the thermal energy from the electronic component to the refrigerant. Finally, the refrigerant is sent back to the compressor. The compressor, the condenser, the compact cooling block, and the controller all fit within a chassis of the computer.

### Liquid Chiller System

Currently, some high-end computers include liquid cooling systems for cooling the CPU of the computer. These liquid cooling systems generally include a pump or circulator, a cooling block, and a radiator. The pump circulates a liquid through the cooling block and radiator. The cooling block is in thermal and physical contact with the CPU and transfers the heat energy from the CPU to the circulating liquid. The radiator cools the circulating liquid by radiating the heat energy absorbed from the liquid. Such liquid cooling systems can be located inside the chassis of the computer.

Like a CPU cooling fan, such liquid cooling systems are not very efficient at lowering the temperature of the CPU, because they are reliant on the ambient air temperature to provide the cooling. In addition, liquid cooling systems are susceptible to condensation, which can destroy electronic components of the computer.

In various embodiments, the radiator of a conventional liquid cooling system is replaced by a liquid chiller system that more efficiently lowers the temperature of the circulating liquid and prevents condensation inside the computer enclosure. The liquid chiller system, for example, fits inside the drive bays of a computer enclosure or chassis and connects to an existing liquid cooling system (plug and play). The liquid chiller system can also receive power from the power supply of the computer.

The liquid chiller system, for example, includes a controller, a compressor, a mini heat exchanger, a condenser coil, and a fan all enclosed in a box. A user plugs an existing liquid cooling circuit into the outside of the box, using quick connects/disconnects so that the box can be easily installed and uninstalled for maintenance. The liquid in the existing liquid cooling circuit can be, but is not limited to, water, glycol, or a dielectric fluid. A dielectric fluid can include, but is not limited to, Fluorinert™. The liquid goes into the heat exchanger, gets cooled, and then goes back to the liquid cooling circuit. The heat exchanger has two circuits intertwined: one for the liquid, and the other for the refrigerant. A brazed plate heat exchanger, for example, can be used. The refrigerant circuit acts as the evaporator of the refrigerant cycle and cools the liquid circuit (which cools the liquid).

In various, embodiments, the temperature of the liquid is controlled using one or more temperature and humidity sensors. The temperature sensors, for example, are used to measure the temperature of the liquid and the temperature of the ambient air. At least one humidity sensor is used, for example, to measure the humidity of the ambient air. The controller inside the liquid chiller system receives the measured temperatures and humidities from the one or more temperature and humidity sensors.

In one embodiment, the controller inside the liquid chiller system receives the measured temperatures and humidities, calculates a temperature range at or near the dew point for the liquid based on these measurements, and increases or reduces the speed of the compressor to keep the liquid of the liquid cooling system within the calculated temperature range. Reducing the speed of the compressor can include stopping the compressor, for example. The calculated temperature range is a temperature range that keeps the liquid as cold as possible, yet near or above the dew point of the ambient air in order to prevent condensation. Temperature and humidity measurements are needed to calculate a dew point, for example.

In an alternative embodiment, the controller inside the liquid chiller system communicates with the computer to control the temperature of the liquid. For example, the controller receives the measured temperatures and humidities and sends the measured temperatures and humidities to the computer. The computer calculates a temperature range for the liquid based on these measurements and sends control signals to the controller to increase or reduce the speed of the compressor to keep the liquid of the liquid cooling system within the calculated temperature range. The controller is in communication with the computer using either a wired or wireless connection. A wired connection can include, but is not limited to, a serial or universal serial bus (USB) connection. A wireless connection can include, but is not limited to, Wi-Fi, Bluetooth, 4G (network), two way dynamic radiofrequency identification (RFID) control, or near field communication (NFC).

In various embodiments, the controller of the liquid chiller system or the computer can receive input from a user and calculate a temperature range for the liquid based on the received input. In various embodiments, the controller of the liquid chiller system or the computer can also provide information to the user about the temperature of the liquid. In various embodiments, a temperature display and/or thermostat may be placed on the exterior container of the liquid chiller so that the user may see the current temperature or input the desired temperature. In one embodiment, the liquid chiller is placed in the drive bay(s) of the computer chassis so that the temperature display and/or thermostat is visible and accessible to the user on the outside of the computer chassis.

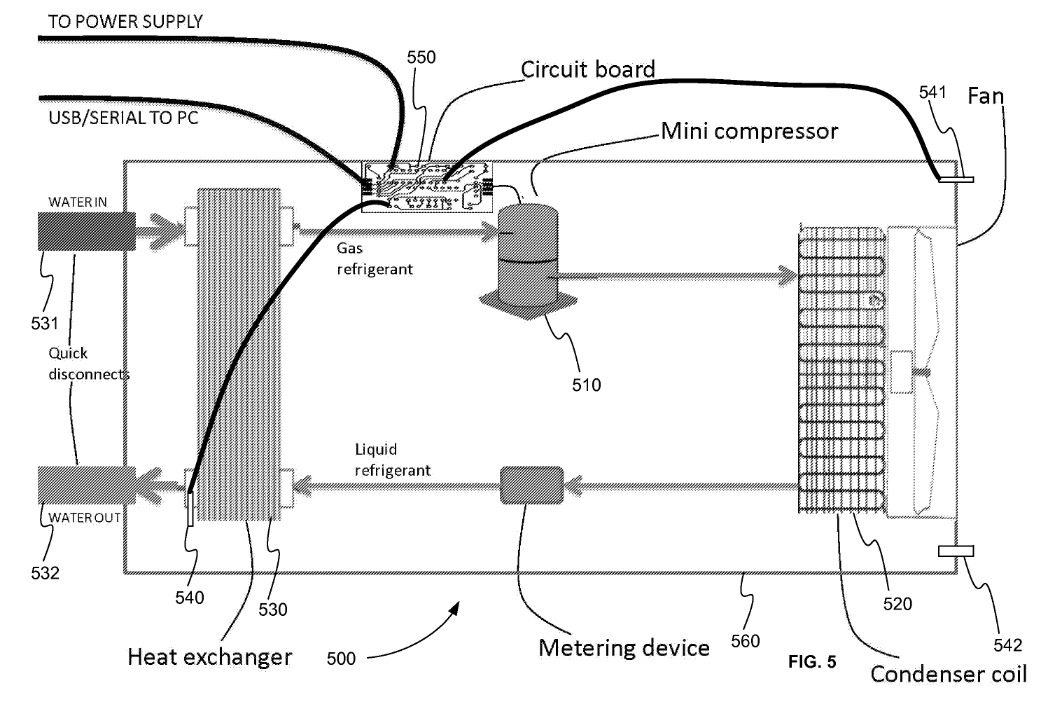

FIG. 5 is schematic diagram of a system 500 for controlling the temperature of a circulating liquid used to control the temperature of an electronic component of a computer, in accordance with various embodiments. System 500 is, for example, a liquid chiller. System 500 includes compressor 510, condenser 520, heat exchanger 530, temperature sensor 540, and controller 550.

Compressor 510 compresses a refrigerant. Condenser 520 receives the refrigerant from compressor 510 and condenses the refrigerant. Heat exchanger 530 is thermally coupled to a circulating liquid used to control the temperature of an electronic component of a computer. Heat exchanger 530 receives the refrigerant from condenser 520 and transfers thermal energy from the circulating liquid to the refrigerant. The circulating liquid enters heat exchanger 530 through port 531 and exits through port 532, for example. The circulating liquid can be, but is not limited, to water, glycol, or a dielectric fluid.

Temperature sensor 540 measures the temperature of the circulating liquid. Controller or circuit board 550 is in electronic communication with compressor 510 and temperature sensor 540. Controller 550 controls the compressor in order to maintain a temperature range for the circulating liquid.

In various embodiments, controller 550 controls the compressor in order to maintain the temperature of the circulating liquid near or above a dew point of the circulating liquid. Controller 550 can calculate a temperature range for the circulating liquid using the measured temperature of the circulating liquid received from temperature sensor 540. In order to calculate the dew point of the circulating liquid, however, additional measurements are needed. For example, controller 550 can calculate the dew point of the circulating liquid using a measured temperature of the ambient air received from temperature sensor 541 and a measured humidity of the ambient air received from humidity sensor 542.

In various alternative embodiments, controller 550 is in electronic communication with the computer. Electronic communication can include, but is not limited to, data communication or control signal communication. The computer can receive temperature and humidity measurements from controller 550 and calculate the temperature range for the circulating liquid. The computer can then send signals to controller 550 to control the speed of compressor 510 in order to maintain the temperature of the circulating liquid within the calculated temperature range.

Electronic communication between controller 550 and the computer can be wired or wireless. Protocols for this electronic communication can include, but are not limited to, USB, Wi-Fi, Bluetooth, 4G (network), two RFID control, or NFC.

In various embodiments, compressor 510, condenser 520, heat exchanger 530, temperature sensor 540, and controller 550 all fit within an enclosure or box 560. Enclosure 560 can be placed inside a chassis of a computer. Enclosure 560 can be placed in a drive bay of the computer, for example.

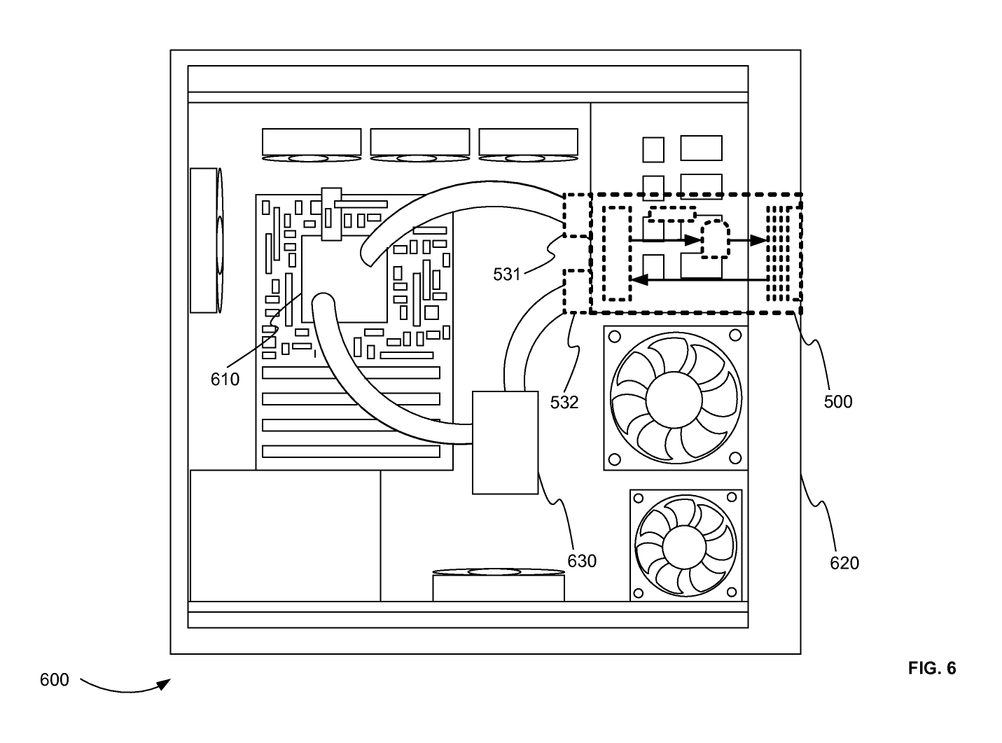

FIG. 6 is a schematic diagram of a computer 600 that contains a system for controlling the temperature of a circulating liquid used to control the temperature of an electronic component of the computer, in accordance with various embodiments. Computer 600 includes system 500 for controlling the temperature of a circulating liquid used to control the temperature of electronic component 610 of computer 600. Electronic components may include any component that creates heat inside a computer, including but not limited to, the CPU, GPU, network cards, and portions of the motherboard.

System 500 is located in a drive bay of computer chassis or enclosure 620, for example. System 500 is connected to the fluid circuit of the circulating liquid of computer 600 through ports 531 and 532. Pump 630 circulates a liquid between electronic component 610 and system 500. A temperature display and/or thermostat control may be placed on the exterior of system 500 so as to be viewable and accessible by the user on the exterior of computer chassis or enclosure 620.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

1. A system for controlling the temperature of an electronic component of a computer, comprising:
a compressor that compresses a refrigerant;
a condenser that receives the refrigerant from the compressor and condenses the refrigerant;
a compact cooling block that is thermally coupled to an electronic component of a computer, receives the refrigerant from the condenser, and transfers thermal energy from the electronic component to the refrigerant; and
a controller in electronic communication with the compressor that controls the compressor based on a pulse-width modulation (PWM) signal showing a measured temperature of the electronic component in order to maintain a pre-defined temperature range for the electronic component,
wherein the compressor, the condenser, the compact cooling block, and the controller all fit within a chassis of the computer.

2. The system of claim 1, wherein the PWM signal is received from a basic input/output system (BIOS) of the computer.

3. The system of claim 1, wherein the controller converts the PWM signal to a 0-5 direct current (DC) linear voltage signal to control the speed of the compressor.

4. The system of claim 1, wherein the controller adjusts the speed of the compressor in order to maintain the pre-defined temperature range for the electronic component.

5. The system of claim 1, wherein the controller turns the compressor on and off in order to maintain the pre-defined temperature range for the electronic component.

6. The system of claim 1, further comprising a sensor capable of measuring the temperature of the electronic component and the temperature and humidity of the ambient air, wherein the sensor provides a redundant security check and acts as a secondary controller.

7. The system of claim 1, wherein the PWM signal is configured by a user directly using a basic input/output system (BIOS) of the computer, software, or application programmable interface (API) by inputting a temperature or range of temperatures that the user wants to keep the electronic component.

8. The system of claim 1, wherein the condenser includes a fan.

9. The system of claim 1, further comprising a back plate that attaches the compact cooling block to the electronic component.

10. The system of claim 1, wherein the compressor includes a direct current (DC) motor and a compression mechanical chamber, and wherein the compressor is located within an enclosure.

11. The system of claim 10, wherein the compressor further includes a shaft that provides a link between the DC motor and the compression mechanical chamber, and wherein by extending the shaft, the DC motor is located outside of the enclosure, allowing easy maintenance and retrofit of the DC motor.

12. A method for controlling the temperature of an electronic component of a computer, comprising:
receiving a pulse-width modulation (PWM) signal that indicates a temperature of an electronic component of a computer; and
controlling a compressor based on the received PWM signal to maintain a pre-defined temperature range for the electronic component, wherein the compressor compresses a refrigerant, the refrigerant is sent to a condenser that condenses the refrigerant, the refrigerant is sent to a compact cooling block that is thermally coupled to the electronic component and that transfers thermal energy from the electronic component to the refrigerant, and the refrigerant is sent back to the compressor,
wherein the compressor, the condenser, the compact cooling block, and the controller all fit within a chassis of the computer.

13. A computer program product, comprising a non-transitory computer-readable storage medium whose contents include a program with instructions being executed on a processor so as to perform a method for controlling the temperature of an electronic component of a computer, the method comprising:
providing a system comprising distinct software modules that comprise a receiving module and a control module;
receiving a pulse-width modulation (PWM) signal that indicates a temperature of an electronic component of a computer using the receiving module; and
controlling a compressor based on the received PWM signal to maintain a pre-defined temperature range for the electronic component using the control module, wherein the compressor compresses a refrigerant, the refrigerant is sent to a condenser that condenses the refrigerant, the refrigerant is sent to a compact cooling block that is thermally coupled to the electronic component and that transfers thermal energy from the electronic component to the refrigerant, and the refrigerant is sent back to the compressor,
wherein the compressor, the condenser, the compact cooling block, and the controller all fit within a chassis of the computer.

14. A system for controlling the temperature of a circulating liquid used to control the temperature of an electronic component of a computer, comprising:
a compressor that compresses a refrigerant;
a condenser that receives the refrigerant from the compressor and condenses the refrigerant;
a heat exchanger that is thermally coupled to a circulating liquid used to control the temperature of an electronic component of a computer that receives the refrigerant from the condenser and transfers thermal energy from the circulating liquid to the refrigerant;
a temperature sensor that measures the temperature of the circulating liquid; and
a controller in electronic communication with the compressor and the temperature sensor that controls the compressor in order to maintain a temperature range for the circulating liquid.

15. The system of claim 14, wherein the compressor, the condenser, the heat exchanger, and the controller all fit within a chassis of the computer.

16. The system of claim 14, wherein the compressor, the condenser, the heat exchanger, and the controller can plug into an existing water cooling circuit of a computer by replacing the radiator or other heat exchange device.

17. The system of claim 14, wherein the compressor, the condenser, the heat exchanger, and the controller can plug into an existing water cooling circuit of a computer through the use of quick-disconnects.

18. The system of claim 14, wherein the compressor, the condenser, the heat exchanger, and the controller can fit within the drive bays of a computer chassis.

19. The system of claim 14, wherein the temperature range comprises a temperature range near or above a dew point of the circulating liquid.

20. The system of claim 14, wherein the circulating liquid comprises water.

21. The system of claim 14, wherein the circulating liquid comprises glycol.

22. The system of claim 14, wherein the circulated liquid comprises a dielectric fluid.

23. The system of claim 22, wherein the dielectric fluid comprises Fluorinert™.

24. The system of claim 14, wherein the computer is in electronic communication with the controller and controls the controller.

25. The system of claim 14, wherein the data communication comprises universal serial bus (USB), Bluetooth, 4G (network), two way dynamic radiofrequency identification (RFID) control, or near field communication (NFC).
